(19) United States
(12) Patent Application Publication
(10) Pub. No.: US 2024/0047711 A1
(43) Pub. Date: Feb. 8, 2024

(54) Electrochemical Cell with Improved Peripheral Sealing

(71) Applicants: SYMBIO, FONTAINE (FR); COMMISSARIAT À L'ENERGIE ATOMIQUE ET AUX ENERGIES ALTERNATIVES, PARIS (FR)

(72) Inventors: Christophe Baverel, Audincourt (FR); Yannick Godard, Blussans (FR); Jean-Philippe Poirot-Crouvezier, Grenoble (FR); Pierre-André Jacques, Grenoble (FR)

(21) Appl. No.: 18/277,007

(22) PCT Filed: Feb. 15, 2022
(86) PCT No.: PCT/EP2022/053599

§ 371 Date: Aug. 11, 2023

(30) Foreign Application Priority Data
Feb. 16, 2021 (FR) FR2101483

(51) Int. Cl. H01M 8/0273; H01M 8/0286; H01M 8/1018; C25B 9/60

(52) U.S. Cl. CPC H01M 8/0273; H01M 8/0286; H01M 8/1018; C25B 9/60; H01M 8/0258

(57) ABSTRACT

The invention relates to an electrochemical cell having: ∘a membrane electrode assembly (2); ∘two retaining plates (10); ∘a single seal (20) extending around the membrane electrode assembly (2) and disposed in contact with the two retaining plates (10); ∘at least one intermediate leaktight sheet (30) extending around the membrane electrode assembly (2), disposed between the latter and the seal (20) and joined in a leaktight manner to the membrane (4) on the one hand and to the seal (20) on the other.

### TECHNICAL FIELD

The field of the invention is the field of proton exchange membrane electrochemical cells such as electrochemical cells for fuel cells or electrolyzers, and more precisely relates to the peripheral sealing of the electrochemical cell at least around the active zone thereof.

### PRIOR ART

Proton Exchange Membrane (PEM) electrochemical cells comprise an anode and a cathode electrically separated from each other by the electrolytic membrane. The stack of the electrodes and of the electrolytic membrane is called membrane electrode assembly (MEA). Same can be the cells of an electrochemical reactor such as a fuel cell or an electrolyzer.

An electrochemical cell usually comprises two retaining plates, between which the membrane electrode assembly is arranged. The retaining plates are called bipolar plates when, in a stack of electrochemical cells, the plates are each in contact with the anode of a cell on one side, and with the cathode of the adjacent cell on the other side. The plates are suitable for providing the mechanical support of the membrane electrode assembly, the fluidic distribution of the reactive gases at the electrodes, and the electrical connection of the electrodes. Furthermore, the retaining plates usually include distribution channels situated on the sides oriented towards the membrane electrode assembly, and suitable for conveying the reactive fluid to the corresponding electrode and for removing the products of the electrochemical reaction.

As an example, in the case of a fuel cell, the fuel (e.g. hydrogen) is brought to the anode whereas the oxidizer (e.g. oxygen contained in the air) is brought to the cathode. The electrochemical reaction is subdivided into two half-reactions, an oxidation reaction and a reduction reaction, which take place at the anode/electrolyte interface and at the cathode/electrolyte interface, respectively. To take place, the electrochemical reaction requires the presence of an ionic conductor between the two electrodes, namely the electrolyte contained in a polymer membrane, and a conductor of electrons formed by the external electrical circuit. Thereby, the cell is the site of the electrochemical reaction: the reactive gases are brought thereto, the products and the non-reactive species are removed therefrom, as well as the heat produced during the reaction.

In addition, it is important to provide the peripheral sealing of the electrochemical cell, i.e. the sealing around the active zone where the electrochemical reactions take place, so as to prevent the fluids circulating through the distribution channels from leaking out of the electrochemical cell.

As such, FIG. 1A illustrates an example of a PEM electrochemical cell 1 described in the document US2004/0209150. The peripheral sealing around the active zone is provided by two seals 20.1, 20.2 arranged on both sides of the membrane 4, and which extend continuously around the active zone (and herein around the inlet and outlet manifolds (not shown in the figure)). Thereby, each seal 20.1, 20.2 is in contact with a bipolar plate 10 and a face of the membrane 4. However, the fact of using two seals 20.1, 20.2 superimposed one on the other, leads to stricter requirements in terms of manufacturing tolerances for the thickness of the seals. It is indeed necessary to control precisely the thickness of the seals 20.1, 20.2 during manufacture, which is particularly difficult insofar as the seals could have a thickness on the order of one millimeter or even less. Furthermore, manufacturing tolerances which are not sufficiently small can lead to localized leakage in the XY plane of the electrochemical cell.

To reduce such requirements in terms of manufacturing tolerances for seal thickness, document US2019/0036130 describes another PEM electrochemical cell 1 configuration, as illustrated in FIG. 1B. Herein the peripheral sealing around the active zone is provided by the same seal 20. The seal 20 is in contact with the two bipolar plates 10 and with an outer edge of the electrolytic membrane 4 (and here of the MEA 2). More precisely, the seal 20 is joined to the MEA 2 by overmolding. Although the use of a single seal 20 reduces the requirements in terms of thickness, such configuration has the drawback that a localized contact defect between the seal 20 and the membrane 4 can lead to a localized leak, along the Z axis, between the two sides of the membrane 4 (herein via the diffusion layers of the electrodes 3). Moreover, such solution requires that the seal 20 is made of a material having chemical compatibility with the materials of the MEA 2.

### OUTLINE OF THE INVENTION

The aim of the invention is to remedy at least in part the drawbacks of the prior art, and more particularly to propose a proton exchange membrane electrochemical cell with improved peripheral sealing.

For this purpose, the subject matter of the invention is an electrochemical cell including: a membrane electrode assembly, including a proton exchange electrolytic membrane; two retaining plates, situated on both sides of the membrane electrode assembly, including distribution channels for distributing reactive fluids to the electrodes; and only one seal, along a thickness axis orthogonal to a main plane of the electrochemical cell, (i.e. a single seal along the thickness axis), extending around the membrane electrode assembly in the main plane, and arranged in contact with the two retaining plates.

According to the invention, the electrochemical cell includes at least one intermediate leak-tight sheet, extending around the membrane electrode assembly in the main plane, and arranged between the latter and the seal, made of a material liquid-tight with regard to the fluids intended for circulating in the distribution channels, and joined in a leak-tight way to the membrane and to the seal.

In addition, the retaining plates have retaining ribs protruding with respect to the main plane and coming into contact with the seal. The intermediate leak-tight sheet is joined to a surface of the seal, which is situated:
radially between the membrane electrode assembly and the retaining ribs; and
radially at a non-zero distance from the membrane electrode assembly and the retaining ribs.

Radially means: along an axis contained in the main plane and oriented orthogonally, or opposite, to the membrane electrode assembly. Moreover, at non-zero distance means that the surface of the seal joined to the sheet is entirely spaced apart, in the principal plane, from the MEA and from the retaining ribs.

It will then be understood that the leak-tight junction between the intermediate leak-tight sheet and the seal lies outside the leak-tight junction formed by the contact of the retaining ribs on the seal. In addition, the sheet/seal leak-tight junction is entirely surrounded, in the main plane, by the seal/ribs leak-tight junction, and is thus not superimposed on the latter along the thickness axis. Thereby, the risk of leaks is further reduced. In addition, the mechanical forces induced by the clamping of the joint between the retaining ribs of the two retaining plates, and any deformations which could result therefrom, are not directly applied to the intermediate leak-tight sheet, reducing the risk that such deformations are subsequently transferred to the MEA.

It should be noted herein that the electrochemical cell includes only one single seal, along the thickness axis, in contact with the retaining ribs. In other words, the same seal is in contact, via a first of the faces thereof, with a first retaining plate, and more precisely with a rib for retaining the first retaining plate, and is in contact, via a second face opposite the first face, with a second retaining plate, and more precisely with a rib for retaining the second retaining plate.

Thereby, the sealing between the two retaining plates is provided by the same seal (called the main seal), and not, as in the prior art, by two seals superimposed one on the other along the thickness axis. On the other hand, the electrochemical cell can include other seals, called auxiliary seals, which can e.g. extend around the membrane electrode assembly in the main plane, and which come into contact with the two retaining plates. Such auxiliary joints can either be superimposed or not superimposed along the thickness axis. Same can be either in contact or not in contact with the main seal.

Certain preferred aspects, but not limited to, of the electrochemical cell are the following.

The intermediate leak-tight sheet can be bonded to the membrane by means of an adhesive material.

The intermediate leak-tight sheet can be made of a material different from the material of the seal.

The intermediate leak-tight sheet can be joined to the seal by bonding, overmolding or welding.

The membrane can have two faces opposite each other and parallel to the main plane of the electrochemical cell, the intermediate leak-tight sheet extending over one of said faces of the membrane.

The intermediate leak-tight sheet can be bonded to one of the said faces of the membrane.

The peripheral leak-tight sheet can extend in a peripheral zone of the electrochemical cell, surrounding in the main plane, an active zone where an electrochemical reaction is intended to occur.

The seal can be in contact with retaining ribs of the retaining plates, the retaining ribs protruding with respect to the main plane and arranged facing each other.

The seal can be in contact with retaining ribs of the retaining plates, the retaining ribs protruding with respect to the main plane and arranged offset from each other. Such offset extends along a radial direction with respect to the active zone, in the main plane.

The membrane can have first and second faces opposite each other and parallel to the main plane of the electrochemical cell and can have first and second intermediate leak-tight sheets superimposed on each other, each being joined in a leak-tight way to the membrane and to the seal, the first intermediate leak-tight sheet extending over the first face and the second intermediate leak-tight sheet extending over the second face.

The first intermediate leak-tight sheet can be bonded to the first face, and the second intermediate leak-tight sheet can be bonded to the second face.

The invention further relates to an electrochemical reactor, including a stack of electrochemical cells according to any of the preceding features, the electrochemical reactor being a fuel cell or an electrolyzer.

The invention further relates to a method for manufacturing an electrochemical cell according to any of the preceding features, including a first step of joining the intermediate leak-tight sheet to the seal, followed by a second step of joining the intermediate leak-tight sheet to the membrane.

The first assembly step can be carried out by bonding, welding or overmolding, and the second assembly step can be carried out by bonding.

The second assembly step can be carried out by bonding at a temperature less than or equal to 200° C.

### BRIEF DESCRIPTION OF DRAWINGS

Other aspects, goals, advantages and features of the invention will appear more clearly upon reading the following detailed description of embodiments of the invention, given only as an example, but not limited to, and making reference to the following drawings, wherein:

FIG. 1A, already described, is a schematic and partial cross-section view of an electrochemical cell according to an example of the prior art, including two seals situated on both sides and in contact with the electrolytic membrane;

FIG. 1B, already described, is a schematic and partial cross-section view of an electrochemical cell according to another example of the prior art, including only one seal situated in contact with the electrolytic membrane;

FIG. 2A is a schematic and partial cross-section view of an electrochemical cell according to one embodiment, including an intermediate leak-tight sheet joined in a leak-tight way to the electrolytic membrane and to the same seal;

FIG. 2B is a schematic and partial cross-section view of an electrochemical cell according to a variant of embodiment, wherein two intermediate leak-tight sheets superimposed on each other, each joined in a leak-tight way to the electrolytic membrane and to the same seal;

FIG. 2C is a schematic and partial cross-section view of an electrochemical cell according to a variant of embodiment, wherein the seal is in contact with a plurality of retaining ribs of the retaining plates, the retaining ribs being radially offset from one another.

FIG. 3 is a schematic and partial top view of an electrochemical cell according to the embodiment shown in FIG. 2A.

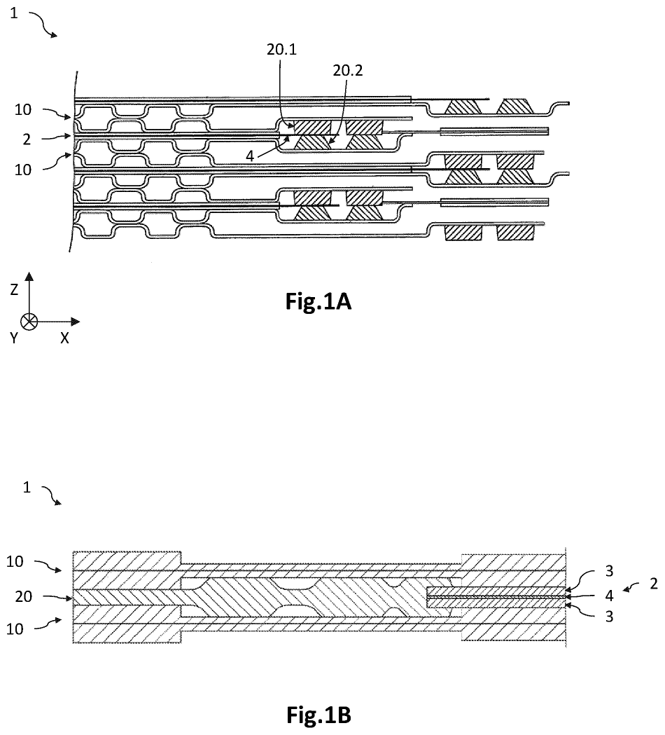

### DETAILED OUTLINE OF PREFERRED EMBODIMENTS

In the figures and hereinafter in the description, the same references represent identical or similar elements. In addition, the different elements are not represented to scale so as to keep the figures clear. Moreover, the different embodiments and variants are not exclusive of one another and can be combined with one another. Unless otherwise stated, the terms “substantially”, “about”, “on the order of” mean within 10%, and preferentially within 5%. Moreover, the terms “comprised between . . . and . . . ” and equivalent terms mean that the bounds are included unless otherwise stated.

The invention relates to a proton exchange membrane (PEM) electrochemical cell. Different embodiments and variants will be described with reference to an electrochemical cell of a PEM fuel cell, and more particularly to a hydrogen cell the cathode of which is supplied with oxygen and the anode of which is supplied with hydrogen. Such a fuel cell can also operate using methanol, among others.

However, the invention applies to any type of PEM fuel cell, more particularly to same working at low temperature, i.e. at a temperature below 200° C., and to low temperature electrochemical electrolyzers, e.g. electrolyzers generating hydrogen and oxygen from water.

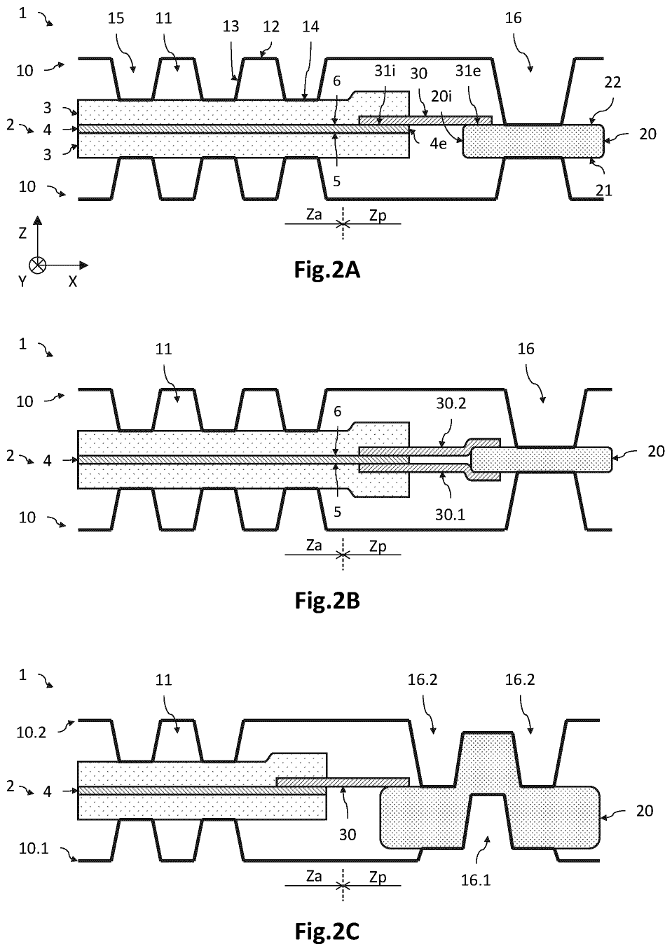

FIG. 2A is a schematic and partial cross-section view of an electrochemical cell 1 according to one embodiment. In such example, the retaining plates 10 are produced using the technology of deep-drawn conductive sheets. However, the technology of the retaining plates based on graphite-filled composite can be used herein. Moreover, in the present example, the peripheral sealing is provided around the MEA 2 but same can be further provided around the inlet and outlet manifolds (not shown).

A direct orthonormal coordinate frame (X, Y, Z) is defined herein and for the rest of the description, where the XY plane extends parallel to the main plane of the electrochemical cell 1, the X axis is oriented along a direction of fluidic flow of the reactive gases, and where the Z axis is oriented along the thickness dimension of the retaining plates 10. The terms “lower” and “upper” refer herein to an increasing positioning along the direction +Z. Moreover, the terms “inner” and “outer” refer to an orientation in the XY plane, directed along the direction of the active zone ZA or along an opposite direction, respectively.

The electrochemical cell 1 includes a membrane electrode assembly (MEA) 2 consisting of two electrodes (anode and cathode) 3 separated from each other by an electrolytic membrane 4. The MEA 2 extends along a main plane of the electrochemical cell parallel to the XY plane. The electrodes 3 and the membrane 4 are conventional elements known to a person skilled in the art.

The electrolytic membrane 4 is a proton exchange membrane. Same is used for the diffusion of protons from an anode to a cathode, where the protons can be present within the membrane 4 in the form of H₃O⁺ ions. Same also provides electrical insulation between the electrodes 3 and is made of a material leak-tight with regard to the fluids circulating in the distribution channels 11 of the retaining plates 10.

Each electrode 3 herein consists of a gas diffusion layer (GDL) and an active layer in contact with the membrane 4. The active layers are the site of electrochemical reactions. Same include materials making possible oxidation and reduction reactions at the interfaces of the anode and of the cathode, respectively, with the membrane 4. The diffusion layers are made of a porous material making possible the diffusion of the reactive species between the distribution channels 11 of the retaining plates 10 and the active layers, as well as the diffusion of the products resulting from the electrochemical reaction.

The MEA is arranged between two retaining plates 10 suitable for supplying reactive gases to the electrodes 3 and for providing the electrical connection of the latter. Same can also be suitable for removing the heat produced during the electrochemical reaction, and for removing the products resulting from the electrochemical reaction. Each retaining plate 10 includes distribution channels 11 oriented towards the corresponding electrode 3. Each distribution channel 11 is formed by a bottom wall 12, a side wall 13, and is separated from the adjacent distribution channel 11 by a contact wall 14. There is thus a lateral alternation of distribution channels 11 and separation ribs 15 (which are formed by the walls 13 and 14).

Moreover, the retaining plates 10 herein each include at least one retaining rib 16, situated in the peripheral zone ZP which surrounds the active zone ZA. A retaining rib 16 is a portion of the retaining plate which has a protrusion with respect to the XY plane. Same is formed by a side wall and a contact wall intended for being in contact with the seal 20. The lower and upper retaining ribs 16 can be superimposed on one another (i.e. perpendicular to one another), as illustrated in FIG. 2A, or even be radially offset with respect to one another, as illustrated in FIG. 2C. “Radially” means along a radial direction in the XY plane and opposite the active zone ZA. As discussed in detail hereinbelow, the seal 20 is in contact with the retaining plates 10 at the retaining ribs 16.

The active zone ZA extends in a XY plane and corresponds to the zone where the electrochemical reactions occur. Same can be defined by the zone where the electrodes 3 are situated, and/or by the zone where the distribution channels 11 extend. An electrolytic ink can be arranged only in the active zone ZA, and not in the peripheral zone ZP (although, in a variant, same can be arranged over the entire surface of the membrane 4, and thus also in the zone ZP). The peripheral zone ZP extends in the XY plane and continuously surrounds the active zone ZA. In the present example, the membrane 4, and herein the MEA 2, includes an edge which is present in the peripheral zone ZP. The seal 20 is situated in the peripheral zone ZP, as well as the intermediate leak-tight sheet or sheets 30.

The electrochemical cell 1 includes a one and same seal 20, which is unique along the thickness Z axis, and which provides peripheral sealing around the active zone ZA and thus prevents the fluids circulating in the distribution channels 11 and in the MEA 2 from leaking out of the electrochemical cell 1.

The peripheral sealing is provided by the only seal 20 which provides contact between the two retaining plates 10, unlike the document US2004/0209150 which describes a superposition of two superposed seals along the axis of thickness Z, and distinct from each other. On the other hand, as indicated hereinabove, if the same seal 20 (called the main seal) is in contact with the two retaining plates 10, the electrochemical cell 1 can include at least one other seal (called auxiliary seal). Such auxiliary seal(s) can be either superposed along the thickness Z axis, or not superposed (in which case the same auxiliary seal is in contact with the two retaining plates 10). Same may either be in contact or may not be in contact with the main seal 20.

The seal 20 herein extends continuously around the active zone ZA in the XY plane. As indicated in document US2004/0209150, the seal 20 can further extend around the inlet and outlet manifolds.

The seal 20 herein is situated in contact with two retaining ribs 16, lower and upper, of the retaining plates 10. In the present example, the retaining ribs 16 are arranged facing each other along the Z axis, but same can have a radial offset in the plane, as discussed in detail below with reference to FIG. 2C.

Herein, the seal 20 is made, depending on its thickness, of the same material and in one-piece. Same provides sealing in the XY plane, by contact (and preferentially compression) with the two retaining plates 10. Furthermore, depending on the thickness of the electrochemical cell 1, the same seal extends along the Z axis, for contacting the two retaining plates 10. Moreover, along the longitudinal extent thereof in the XY plane, the seal 20 is preferentially made of the same material and in one-piece, but same can be made of sections of different materials, the sections being joined to one another in a leak-tight way.

The seal 20 is preferentially made of an elastic material so as to provide a leak-tight contact by compression with the two retaining plates 10. The above can be, among others, silicone or an elastomer (e.g. EPDM), fluorinated (e.g. FKM) if appropriate. The seal 20 can have a thickness on the order of one millimeter, or even one tenth of a millimeter.

The electrochemical cell 1 further includes at least one intermediate leak-tight sheet 30, ensuring a leak-tight assembly between the membrane 4 and the seal 20.

The intermediate leak-tight sheet 30 is thereby arranged between the membrane 4 and the seal 20 in the XY plane. Same is made in one-piece and preferentially of only one material. Preferentially, same continuously surrounds the active zone ZA in the XY plane.

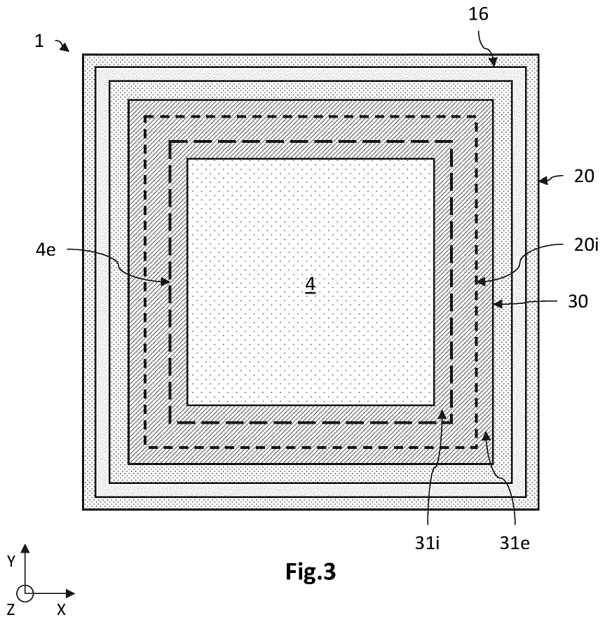

It is a sheet insofar as same has a thickness smaller than the width and length dimensions thereof in the XY plane. Same can extend in the XY plane in the form of a strip, the length then being longer than the width thereof. As such, FIG. 3 is a schematic and partial top view of the electrochemical cell 1 illustrated in FIG. 2A. Same shows thereon the seal 20 which extends continuously around the membrane 4. The inner limit 20i (short dotted lines) of the seal 20 is thus laterally spaced apart from the limit 4^{e} (long dotted lines) of the membrane 4. The retaining rib 16 extends in contact with the seal 20. The intermediate leak-tight sheet 30 extends longitudinally in the XY plane, being continuously in contact with the membrane 4 (forming an inner junction 31i) and in contact with the seal 20 (forming an outer junction 31^{e}).

The intermediate leak-tight sheet 30 is joined in a leak-tight way to the membrane 4 and to the seal 20. Same thus forms two leak-tight junctions 31, a so-called inner junction 31i with the membrane 4, and a so-called outer junction 31^{e} with the seal 20. In other words, the intermediate leak-tight sheet 30 includes an inner edge joined to the membrane 4 (inner junction 31i), an outer edge joined to the seal 20 (outer junction 31^{e}), and a main part extending in the XY plane between the inner and outer edges.

The intermediate leak-tight sheet 30 extends over one of the main faces 5, 6 of the membrane 4, herein the upper main face 6 of the membrane 4, and is joined therein in a leak-tight way, possibly being in contact with the face in question. Same can be joined to the lower main face 5. The inner junction 31i is situated in the peripheral zone ZP, so as not to disturb the electrochemical reactions which could be initiated by the possible presence of the intermediate leak-tight sheet 30 in the active zone ZA. The radial dimension of the inner junction 31i (along a direction opposite the active zone ZA, in the XY plane) can be on the order of a few millimeters, or even tenths of a millimeter.

Preferentially, the intermediate leak-tight sheet 30 is bonded to one of the faces of the membrane 4 by means of an adhesive material which can be cross-linked at low temperature, e.g. at a temperature less than or equal to 200° C., e.g. on the order of 100° C. to 150° C. or which can be cross-linked using ultraviolet radiation. The adhesive material can in particular be an epoxy adhesive, a silane-modified polymer adhesive (MS polymer) or a cyanoacrylate adhesive. Same is chosen depending on the chemical compatibility thereof with the materials of the membrane 4 and/or of the MEA 2.

The intermediate leak-tight sheet 30 thus extends over a surface of the seal 20, herein upper face 22 thereof (although same can extend over the lower face 21, or even against the lateral face). It can be bonded to the seal 20 by means of an adhesive material which can be cross-linked at low temperature or under ultraviolet light. It can also be joined by overmolding, as described hereinafter with reference to FIG. 2B, or even by hot welding.

The intermediate leak-tight sheet 30 can be made of a material different from the material of the seal 20, e.g. of a polymer material such as PEN (polyethylene naphthalate) or PET (polyethylene terephthalate). The material is leak-tight with regard to the fluids circulating in the electrochemical cell 1, and more precisely in the distribution channels 11 of the retaining plates 10 and in the MEA 2.

Thereby, the electrochemical cell 1 has an improved peripheral sealing insofar as the sealing is provided jointly by the same seal 20 coming into contact with the two retaining plates 10 along the Z axis, and by an intermediate leak-tight sheet 30 joined in a leak-tight manner to the membrane 4 and to the seal 20. In addition, the contact surface of the seal 20 with the intermediate leak-tight sheet 30 is situated between and at a distance from the MEA 2 and the retaining ribs 16 in the XY plane. Thereby, the sheet 30/seal 20 leak-tight junction is entirely surrounded in the XY plane by the seal 20/ribs 16 leak-tight junction, without there being any overlaying, even partial, of the junctions along the thickness Z axis, thereby reducing the risks of leaks. Moreover, the risks that the mechanical stresses to which the seal 16 is subject, due to the forces exerted by the ribs 16, degrading the sealing quality of the sheet 30/MEA junction, or yet degrading the intermediate sheet 30 or the MEA 2 are being limited.

Furthermore, the risks of leaks in the XY plane are being limited by the use of the same seal 20, which is unique along the thickness Z axis and which comes into contact with the two retaining plates 10, and not, like in the example of the aforementioned document US2004/0209150, by the use of two seals. Indeed, the manufacturing tolerances of seals can lead, with two superimposed seals, to risks of leakage in the XY plane. Such risks are reduced by the use of the same seal 20. In addition, the risks of weakening of the membrane 4 which can occur when a shear force is present between the two seals described in document US2004/0209150 are being limited.

In addition, the risk of leakage along the Z axis is being limited by the use of the intermediate leak-tight sheet 30 which is joined in a leak-tight way to at least one of the main faces 5, 6 of the membrane 4 and to the seal 20, and in particular the risks of leaks between the two diffusion layers 3 are being limited by bypassing the membrane 4. It is thereby clearly distinguished from the document US2019/0036130 mentioned above where the seal is overmolded to the MEA 2 and thus comes into contact only with the lateral surface of the membrane (which increases the risks of leaks by bypassing the membrane 4, at the interface with the seal). In the invention, the inner junction between the intermediate leak-tight sheet 30 and the membrane 4 can have a larger surface area than in the cited document, thereby improving the sealing efficiency.

Moreover, since the seal 20 is not joined directly to the membrane 4, the seal 20 has fewer requirements in terms of the choice of the sealing material. Indeed, in document US2019/0036130 where the seal is joined to the MEA by overmolding, it is necessary to choose a sealing material which is chemically compatible with the materials of the MEA. Such requirement is removed within the framework of the invention.

Moreover, the method for manufacturing the electrochemical cell 1 can include two different steps of joining the intermediate leak-tight sheet 30 to the seal 20 and to the membrane 4, used for limiting the risks of deterioration or pollution of the membrane 4 and of the MEA 2.

Thereby, in a first step, the assembly to the seal 20 can be carried out before the assembly to the membrane 4, more particularly when the assembly technique is likely to lead to a pollution or a deterioration of the membrane 4 or of the MEA 2, as e.g. in the case of overmolding or hot welding. A low temperature bonding can however be performed.

The intermediate leak-tight sheet 30 can then be joined to the membrane 4 using a technique which is not likely to damage the membrane 4 or the MEA 2, e.g. by low temperature bonding.

FIG. 2B is a schematic and partial cross-section view of an electrochemical cell 1 according to one variant of embodiment. The latter differs from the variant of embodiment shown in FIG. 2A essentially in that same includes two intermediate leak-tight sheets 30.1, 30.2, superposed one on the other, each joined to the membrane 4 and to the seal 20. One is situated above the membrane 4, whereas the other is situated below the membrane 4.

The upper leak-tight sheet 30.2 is then joined in a leak-tight way to the upper main face 6, and more precisely to an upper surface of the peripheral edge of the membrane 4 situated in the peripheral zone ZP, preferentially by adhesive bonding. In addition, same is joined in a leak-tight way to an upper surface of the peripheral inner edge of the seal 20, e.g. by bonding, hot welding, or even overmolding.

Similarly, the lower leak-tight sheet 30.1 is joined in a leak-tight manner to the lower main face 5, and more precisely to a lower surface of the edge of the membrane 4, preferentially by adhesive bonding. In addition, same is joined in a leak-tight way to a lower surface of the peripheral inner edge of the seal 20, e.g. by bonding, hot welding, or even overmolding. In other words, the lower leak-tight sheet 30.1 extends over a first face of the membrane 4 (possibly in contact therewith), and the upper leak-tight sheet 30.2 extends over a second face of the membrane 4 (possibly in contact therewith).

Thereby, an improved mechanical strength is obtained for the indirect assembly of the seal 20 to the membrane 4 by means of the two intermediate leak-tight sheets 30.1, 30.2, thereby improving the peripheral sealing of the electrochemical cell 1.

FIG. 2C is a schematic and partial cross-section view of an electrochemical cell 1 according to another variant of embodiment. Said electrochemical cell differs from same illustrated in FIG. 2A essentially in that the seal 20 is in contact with a plurality of retaining ribs 16 offset with respect to one another along a radial direction.

In said example, the upper plate 10.2 includes two retaining ribs 16.2, and the lower plate 10.1 includes a retaining rib 16.1, arranged radially on both sides of the upper retaining rib 16.2.

Furthermore, the seal 20 is in contact with the two retaining plates 10, and herein is in contact with at least a portion of the three retaining ribs 16. Same is then deformed in the XY plane, more particularly along the radial direction, thereby improving the peripheral sealing of the electrochemical cell 1.

Such deformation of the seal 20 in the XY plane can be obtained without the deformation affecting the assembly thereof with the intermediate leak-tight sheet.

In said example, three retaining ribs 16 are shown, but other configurations are of course possible.

Particular embodiments have just been described. Different variants and modifications will come to mind to a person skilled in the art.

1-15. (canceled)

16. An electrochemical cell comprising:
a membrane electrode assembly, including a proton exchange electrolyte membrane;
two retaining plates, situated on both sides of the membrane electrode assembly, having distribution channels for distributing reactive fluids to the electrodes;
only one seal, along a thickness axis orthogonal to a main plane of the electrochemical cell, wherein said seal extends around the membrane electrode assembly in the main plane and is in contact with the two retaining plates;
at least one intermediate leak-tight sheet, made of a material that leak-tight with respect to fluids intended for circulating in the distribution channels, wherein said intermediate leak-tight sheet extends around the membrane electrode assembly in the main plane and is between the membrane electrode assembly and the seal, and is joined in a leak-tight manner to the membrane and to the seal wherein:
the retaining plates include retaining ribs protruding with respect to the main plane and coming into contact with the seal; and
the intermediate leak-tight sheet is joined to a surface of the seal, wherein the surface of the seal is situated:
radially between the membrane electrode assembly and the retaining ribs; and
radially at a non-zero distance from the membrane electrode assembly and the retaining ribs.

17. The electrochemical cell of claim 16, wherein the intermediate leak-tight sheet is joined to the seal by bonding, overmolding, or welding.

18. The electrochemical cell of claim 3, wherein the intermediate leak-tight sheet is bonded to the membrane with an adhesive material.

19. The electrochemical cell of claim 16, wherein the intermediate leak-tight sheet is made of a material different from the material of the seal.

20. The electrochemical cell of claim 16, wherein the membrane has two faces opposite each other and parallel to the main plane of the electrochemical cell, the intermediate leak-tight sheet extending over one of said faces of the membrane.

21. The electrochemical cell of claim 20, wherein the intermediate leak-tight sheet is made of a material different from the material of the seal and wherein the intermediate leak-tight sheet is bonded to one of said faces of the membrane.

22. The electrochemical cell of claim 16, wherein the peripheral leak-tight sheet extends in a peripheral zone of the electrochemical cell surrounding, in the main plane, an active zone where an electrochemical reaction is intended to occur.

23. The electrochemical cell of claim 16, wherein the retaining ribs are arranged opposite each other.

24. The electrochemical cell of claim 16, wherein the retaining ribs are arranged offset from each other.

25. The electrochemical cell of claim 16, wherein the membrane has first and second faces opposite each other and parallel to the main plane of the electrochemical cell, and having first and second intermediate leak-tight sheets superimposed on each other, each intermediate leak-tight sheet being joined in a leak-tight way to the membrane and to the seal, the first intermediate leak-tight sheet extending over the first face of the membrane, and the second intermediate leak-tight sheet extending over the second face of the membrane.

26. The electrochemical cell of claim 25, wherein the first intermediate leak-tight sheet is bonded to the first face of the membrane, and the second intermediate leak-tight sheet is bonded to the second face of the membrane.

27. An electrochemical reactor comprising a stack of electrochemical cells of claim 4, and wherein the electrochemical reactor is a fuel cell or an electrolyzer.

28. A method for manufacturing an electrochemical cell according to claim 16, comprising a first step of joining the intermediate leak-tight sheet to the seal, followed by a second step of joining the intermediate leak-tight sheet to the membrane.

29. The method of claim 28, wherein the first assembly step is carried out by bonding, welding, or overmolding, and the second assembly step is carried out by bonding.

30. The method of claim 29, wherein the second assembly step is carried out by bonding at a temperature lower than or equal to 200° C.
